(19) United States
(12) Patent Application Publication
(10) Pub. No.: US 2020/0059474 A1
(43) Pub. Date: Feb. 20, 2020

(54) SYSTEM AND METHOD FOR CONTROL SYSTEM CYBERSECURITY

(71) Applicant: Schlumberger Technology Corporation, Sugar Land, TX (US)

(72) Inventors: Juan Rojas, Sugar Land, TX (US); Guillaume Tamboise, Houston, TX (US)

(21) Appl. No.: 16/104,169

(22) Filed: Aug. 17, 2018

(51) Int. Cl. H04L 29/06; H04L 29/08; G06F 8/65; G05B 19/05

(52) U.S. Cl. CPC H04L 63/102; H04L 67/12; H04L 63/0823; G05B 2219/1128; H04L 63/0236; G05B 19/05; G06F 8/65

(57) ABSTRACT

A method may include connecting a network device to a control zone of a drilling management network. The control zone may include a control system that includes a programmable logic controller that performs drilling operations. The method may further include validating that the network device is authorized to communicate with a destination device in the control zone. The method may further include reconfiguring, in response to validating the network device, the control zone to enable the network device to communicate with the destination device. The method may further include obtaining a packet from the network device. The method may further include transmitting, in response to reconfiguring the control zone, the packet to the network device.

### BACKGROUND

Various network devices may be disposed throughout a drilling rig in order to control various operations on the drilling rig. These network devices may control drilling equipment, monitor the performance of the drilling rig, and/or perform various maintenance operations with respect to the drilling rig.

Traditionally, the control side of a drilling rig is intended to operate under very precise conditions. When a network device transmits a command, the response time for executing the command corresponds to a very specific time frame. If no response to the command is received within the specific time frame, then a problem may exist. However, by implementing the control side to operate under such precise timing conditions, the control side is also limited regarding which security measures can be implemented on the control side. Thus, security solutions are desired that are capable of enforcing cybersecurity within a drilling rig while also limiting the security solution's interference with operations performed on the control side.

### SUMMARY

In general, in one aspect, the disclosed technology relates to a method. The method includes connecting a network device to a control zone of a drilling management network. The control zone includes a control system that includes a programmable logic controller that performs one or more drilling operations. The method further includes validating that the network device is authorized to communicate with a destination device in the control zone. The method further includes reconfiguring, in response to validating the network device, the control zone to enable the network device to communicate with the destination device. The method further includes obtaining a packet from the network device. The method further includes transmitting, in response to reconfiguring the control zone, the packet to the network device.

In general, in one aspect, the disclosed technology relates to a method. The method includes obtaining, using a security agent operating on a network device, a software installation file from outside a control zone of a drilling management network. The network device is located inside the control zone. The method further includes obtaining, by the security agent, one or more network device conditions corresponding to the network device. The method further includes determining, by the security agent, whether the one or more network device conditions correspond to a predetermined network state for a software installation on the network device. The method further includes executing, by the security agent, a software installation on the network device using the software update file and in response to determining that the one or more network devices correspond to the predetermined network state.

In general, in one aspect, the disclosed technology relates to a system. The system includes a control system coupled to a various network elements that define a control zone. The control system includes a security agent and a programmable logic controller (PLC) that perform drilling operations. The system further includes a firewall device coupled to the control system. The system further includes a network device and coupled to the firewall device. The security agent communicates with the network device through the firewall device. The security agent installs a software update on the control system in response to communicating with the network device.

Other aspects of the disclosure will be apparent from the following description and the appended claims.

### BRIEF DESCRIPTION OF DRAWINGS

FIGS. 1 and 2 show systems in accordance with one or more embodiments.

FIG. 3 shows an example in accordance with one or more embodiments.

FIGS. 4 and 5 show flowcharts in accordance with one or more embodiments.

FIGS. 6.1 and 6.2 show a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for communicating with network devices in a control zone of a drilling management network. In particular, one or more embodiments are directed to a system that includes a firewall device that couples a control zone with a management zone. For example, control systems for performing drilling operations and maintenance operations may be disposed within the control zone, while the management zone includes network devices that are dedicated to managing and administering processes using the control systems. Likewise, a zero-trust network topology may be implemented within a control zone that only allows network communication between devices with advance authorization.

In some embodiments, one or more security agents are disposed on various network devices within a control zone. A security agent may be a component within a host network device where the security agent is responsible for managing communication with the host network device and devices located outside the control zone. For example, the security agent may monitor its host network device and network traffic to determine different time windows for transferring data. Because of a potentially high network volume, the security agent may need to determine a particular time when a data transfer does not interfere with control processes. In order to perform a software installation, for example, the security agent may need to orchestrate a software installation file transfer to the host network device. After obtaining the file, the software agent may then determine an appropriate time for executing the software installation with the file.

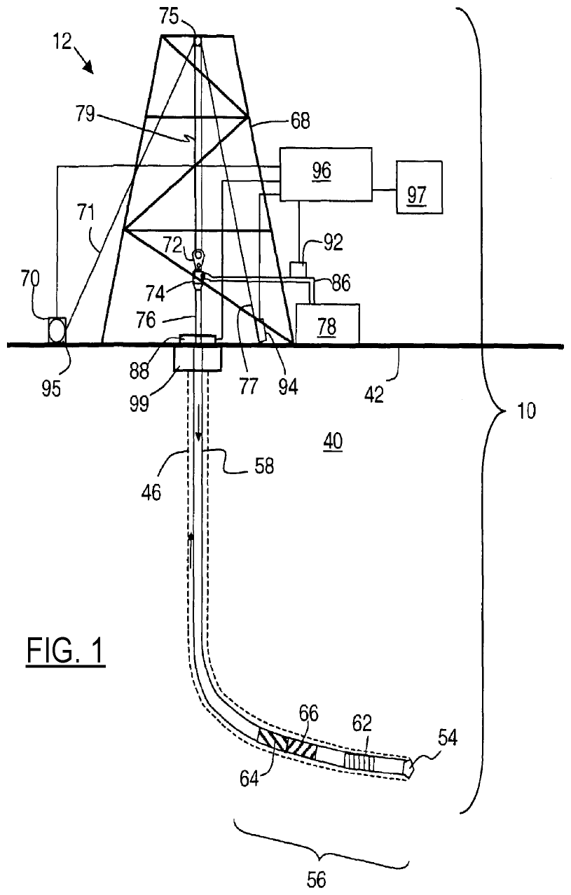

FIG. 1 shows a block diagram of a system in accordance with one or more embodiments. FIG. 1 shows a drilling system (10) according to one or more embodiments. Drill string (58) is shown within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string. The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling. If underbalanced drilling is used, at some point prior to entering the drill string, gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separator (not shown) which may separate the mud from the cuttings. From the separator, the mud may be returned to mud pit (78) for storage and re-use.

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into useable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events.

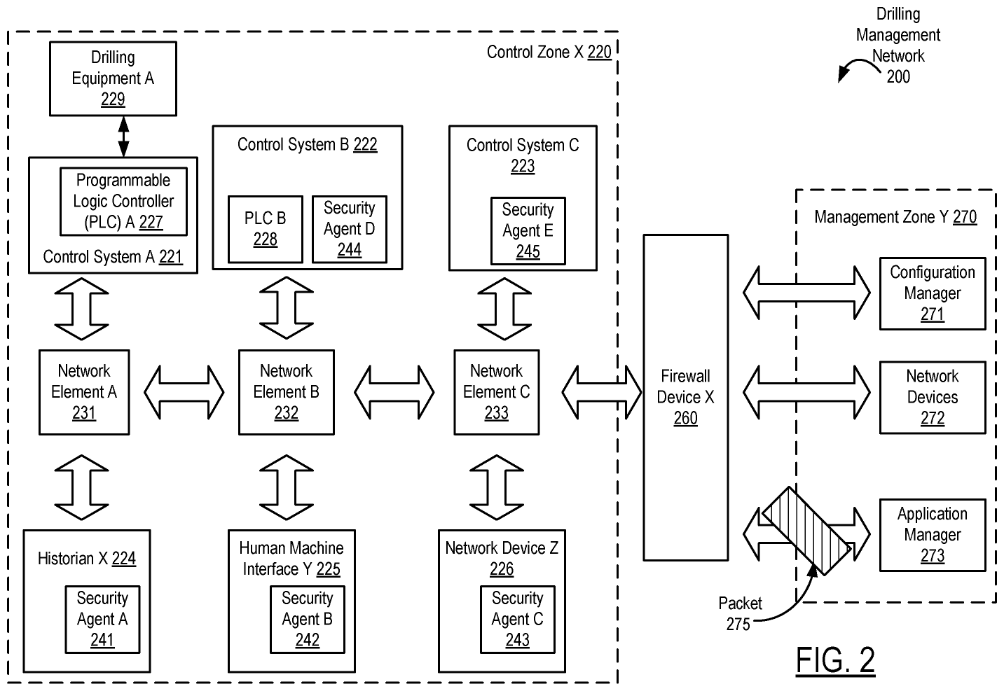

Turning to FIG. 2, FIG. 2 shows a block diagram of a system in accordance with one or more embodiments. As shown in FIG. 2, a drilling management network (200) may include various network zones (e.g., control zone X (220), management zone Y (270)) coupled to a firewall device (e.g., firewall device X (260)). In one or more embodiments, the drilling management network includes a control zone (e.g., control zone X (220)) with various control systems (e.g., control zone A (221), control system B (222), control system C (223)) and network elements (e.g., network element A (231), network element B (232), network element C (233)). In particular, a control zone may include various deterministic systems, such as control systems, that operate in a closed loop network portion of the drilling management network. Within the closed loop portion, control systems may operate using high speed data transfers and precise timing requirements. For example, status requests may occur between network devices in a control zone at very high frequencies, e.g., between microseconds to milliseconds.

Furthermore, control systems may include hardware and/or software with functionality to perform various drilling operations and/or various maintenance operations. For example, drilling operation control systems and/or maintenance control systems may include, for example, programmable logic controllers (PLCs) (e.g., PLC A (227), PLC B (228)) that include hardware and/or software with functionality to control one or more processes performed by a drilling rig, including, but not limited to the components described in FIG. 1. With respect to PLCs, a programmable logic controller may control valve states, fluid levels, pipe pressures, warning alarms, and/or pressure releases throughout a drilling rig. Moreover, a programmable logic controller may be a ruggedized computer system with functionality to withstand vibrations, extreme temperatures, wet conditions, and/or dusty conditions, for example, around a drilling rig. Drilling operation control systems and/or maintenance control systems may also refer to control systems that include multiple PLCs within the drilling management network (200). Moreover, control systems may be coupled to drilling equipment (e.g., drilling equipment A (229), the blowout preventer (99), the drilling rig (12), and other components described above in FIG. 1 and the accompanying description).

Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

In some embodiments, one or more control zones are coupled to a management zone (e.g., management zone Y (270)). For example, the management zone Y (270) may be a portion of the drilling management network (200) that includes various network elements (not shown), network devices (e.g., network devices (272)), one or more configuration managers (e.g., configuration manager (271)), and/or one or more application managers (e.g., application manager (273)). For example, a management zone may be a security safezone outside the control zones. In particular, administration of the network devices within a control zone may be outsourced to other network devices located in one or more management zones.

In some embodiments, a control zone and a management zone are coupled using a firewall device (e.g., firewall device X (260)). For example, a firewall device may include hardware and/or software with functionality to filter data packets (e.g., packet (275)) transmitted between a control zone and a management zone. Specifically, a firewall device may perform a packet inspection at one or more network layers, such as the transport layer, and/or the application layer of a drilling management network. In particular, the firewall device may analyze a packet and/or an application sending a packet to determine whether communication is authorized between a source device and a destination device. In some embodiments, packet authorization is determined using certificate-based authentication. For example, network devices in control zones and management zones may be designated security certificates. A firewall device may include functionality to act as an authentication server to determine whether a security certificate has expired and/or whether a source device (e.g., a configuration manager (271)) is authorized to communicate with a destination device (e.g., control system B (222)).

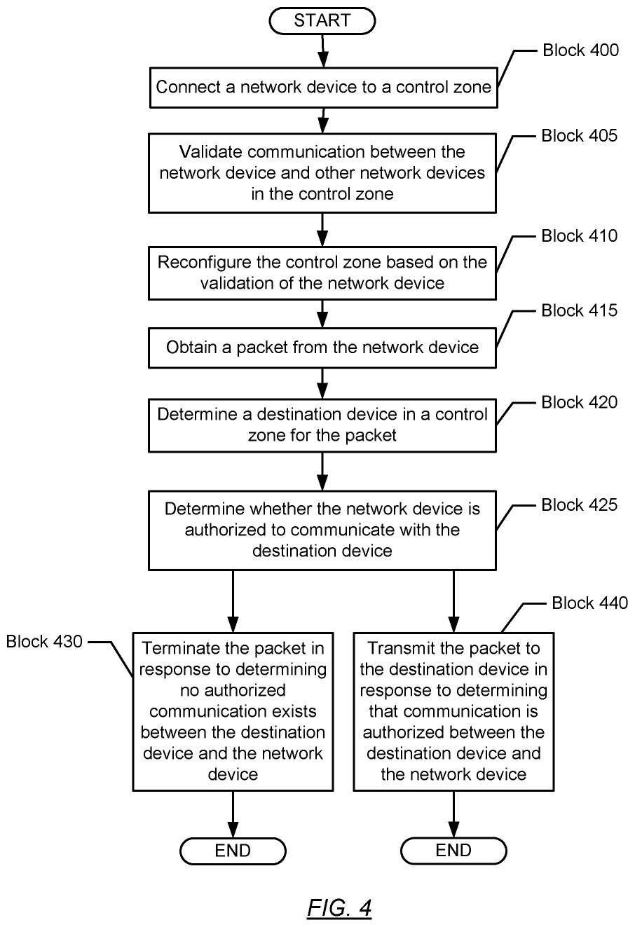

Likewise, by using a firewall device outside a control zone, packet filtering may have a limited impact on network response time within the control zone. Thus, a control zone that operates with a huge volume of data may preserve its computing capacity by being unaffected by a firewall device processing packets. For example, packets entering a control zone are searched, while packets within the control zone may travel unimpeded. For more information on packet filtering between a control zone and a management zone, see FIG. 4 and the accompanying description.

In some embodiments, one or more network devices in a control zone include a security agent (e.g., security agent A (241), security agent B (242), security agent C (243), security agent D (244), security agent E (245)). A security agent may include hardware and/or software with functionality to operate as a local entity on a host network device within a control zone. For example, a security agent may be located on a human machine interface, a historian, one or more control systems, etc. Accordingly, a security agent may have functionality to enforce security rules and access control policies on a respective network device. Thus, a security agent may communicate with a configuration manager and/or an application manager across a firewall device in order to administer software installations and/or software processes on its host network device.

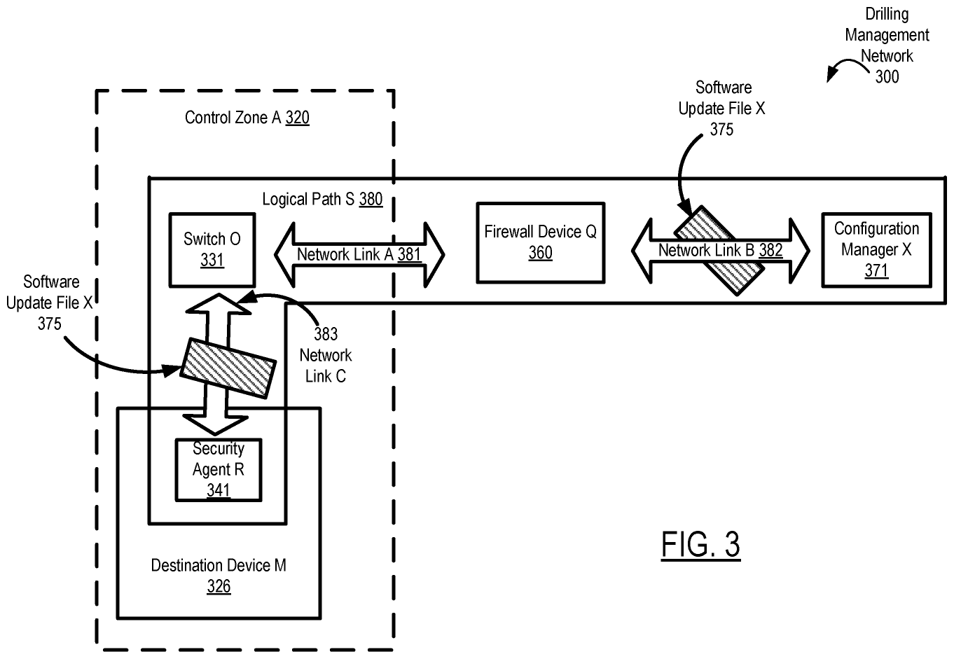

Turning to FIG. 3, FIG. 3 provides an example of a security agent obtaining a software update file. The following example is for explanatory purposes only and not intended to limit the scope of the disclosed technology. In FIG. 3, a security agent R (341) communicates with a configuration manager X (371) acting as a source device over a drilling management network (300). In particular, the security agent R (341) operates on a destination device M (326) that is located in control zone A (320). The security agent R (341) obtains a software update file X (375) over a logical path S (380). The logical path S (380) includes various network links (i.e., network link A (381), network link B (382), network link C (383)) that span a firewall device Q (360) and a switch 0 (331). Thus, the firewall device Q (360) detects that the configuration manager X (371) is authorized to transmit data to destination device M (326) and relays packets associated with the software update file X (375) into the control zone A (320). Within the control zone A (320), the switch 0 (331) determines that packets associated with the software update file X (375) can be relayed to destination device M (326).

Keeping with FIG. 3, once the security agent R (341) obtains the software update file X (375), the security agent R (341) analyzes the control zone A (320) and the destination device M (326) to determine whether network conditions exist for installing the software update file X (375). Once the security agent R (341) detects that network conditions exist for an available installation network state, the security agent R (341) then executes the software update file (375) to update one or more software programs operating on the destination device M (326).

Returning to FIG. 2, in some embodiments, a management zone includes one or more configuration managers (e.g., configuration manager (271)). In particular, a configuration manager may include hardware and/or software that includes functionality for managing software installations and other software processes throughout one or more control zones. For example, a configuration manager may determine whether a new software version exists for a software application operating on a respective device within a control zone. Accordingly, a configuration manager may determine whether the new software version poses any conflicts with a control system and/or other network devices within the control zone and if the new software version warrants being installed on the respective device. As such, the configuration manager may include functionality for managing software updates and other software configuration adjustments. Likewise, adjusting software configurations may include change different software settings, such as computer resources associated with a software application, time settings when software processes operate, etc. In some embodiments, a configuration manager includes functionality for adding and/or removing network devices from a control zone, e.g., by validating and/or devalidating a particular network device.

Moreover, a management zone may include one or more application managers (e.g., application manager (273)). Specifically, an application manager may include hardware and/or software with functionality to manage various closed loop processes performed within a control zone. In particular, an application manager may be remote from control applications being operated by control systems, and thus more flexible than the control applications in regards to computing power and network resources. For example, an application manager may include functionality for coordinating different control systems and other network devices to operate in conjunction and without interference in a control zone.

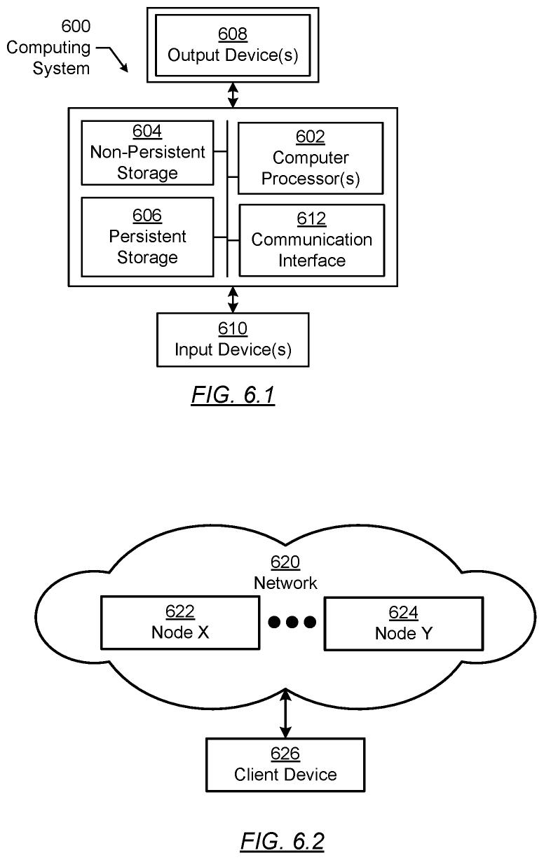

Keeping with FIG. 2, control zones may further include various network devices (e.g., human machine interface (HMI) Y (225), historian X (224), network device Z (226)), and various network elements (e.g., network element A (231), network element B (232), network element C (233)). Network devices may include personal computers, control systems, smal tphones, human machine interfaces, user devices, drilling equipment, onsite user equipment, and any other devices coupled to a drilling management network. A human machine interface may be hardware and/or software coupled to the drilling management network (200), and which includes functionality for presenting data and/or receiving inputs from a user regarding various drilling operations and/or maintenance operations performed within the drilling management network (200). For example, a human machine interface may include software to provide a graphical user interface (GUI) for presenting data and/or receiving control commands for operating a drilling rig. The historian may include hardware and/or software for collecting and/or analyzing sensor data obtained within a control zone. A network element may refer to various hardware components within a network, such as switches, routers, hubs, user equipment, or any other logical entities for uniting one or more physical devices on a network. Network elements, human machine interfaces, historians, network devices, and/or control systems may be computing systems similar to the computing system (600) described in FIGS. 6.1 and 6.2, and the accompanying description.

While FIGS. 1, 2, and 3 show various configurations of components, other configurations may be used without departing from the scope of the disclosure. For example, various components in FIGS. 1, 2, and 3 may be combined to create a single component. As another example, the functionality performed by a single component may be performed by two or more components.

Turning to FIG. 4, FIG. 4 shows a flowchart in accordance with one or more embodiments. Specifically, FIG. 4 describes a method for communicating with one or more network devices in a control zone of a drilling management network. One or more blocks in FIG. 4 may be performed by one or more components (e.g., firewall device X (260)) as described in FIGS. 1, 2, and/or 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, a network device is connected to a control zone in accordance with one or more embodiments. In particular, the network device may establish a network connection with a drilling management network that includes the control zone. The network connection may be established manually by a technician that enables one or more drilling management network ports connected to the network device. The network device may be similar to one of the network devices described in FIG. 2 and the accompanying description, e.g., control system B (222), historian X (224), etc.

In Block 405, communication between a network device and other network devices in a control zone is validated in accordance with one or more embodiments. Specifically, the validation may determine which devices may be authorized destination devices for the validated network device in the control zone. For example, the network device may have one or more network credentials that grant communication access to various devices in the control zone. The network credentials may be provided by a human operator onsite that is setting up the network device in the control zone. Likewise, the network credentials may be stored in the network device and validation may be performed automatically by one or more software protocols operating on the network device and/or the drilling management network. For example, a configuration manager may analyze network credentials for a network device in order to perform the validation.

In some embodiments, a network device broadcasts network credentials throughout a control zone in order to perform a validation. As such, network devices in the control zone may each analyze the network credentials to determine whether the network device may be an authorized source device. Thus, decentralized network protocols may be performed in the control zone for validations.

In Block 410, a control zone is reconfigured based on a validation of a network device in accordance with one or more embodiments. Depending on the destination devices for a validated network device, various network elements, firewall devices, etc. inside and/or outside the control zone may be reconfigured to enable communication between the validated network device and the destination devices.

In some embodiments, for example, a configuration manager in a management zone obtains the validation information associated with a validated network device. As such, the configuration manager may update one or more network tables stored on various switches, routers, etc. in the drilling management network to enable the validated communication.

In Block 415, a packet is obtained from a network device in accordance with one or more embodiments. For example, one or more packets may be transmitted over a logical path that includes a firewall device in a drilling management network. The logical path may includes various network nodes that provide a path through the drilling management network to a control zone, for example. As such, when a firewall device, switch, or other network element in a logical path obtains a packet, further analysis may be performed on the packet by the respective intermediary device.

In Block 420, a determination is made for a packet regarding a destination device in a control zone in accordance with one or more embodiments. In particular, a packet or a source device of the packet may be analyzed to determine the desired destination device. For example, a packet may include a destination network address that specifies the final location of the packet within a drilling management network. Likewise, the control zone and destination device may be similar to the control zones and/or destination devices described above in FIGS. 2 and 3 and the accompanying description.

In some embodiments, a network device in a management zone is associated with a respective device in a control zone. Thus, a firewall device may identify the appropriate destination device based on which device or application is sending the packet.

In Block 425, a determination is made whether a network device is authorized to communicate with a destination device in accordance with one or more embodiments. In particular, a drilling management network may implement various security protocols to ensure that network traffic through a control zone is limited to predetermined types and/or quantities of data. For example, restricting network traffic, even at a firewall device's edge, may not be common. Thus, a firewall device and/or other network elements coupled to a control zone may take a zero-trust approach to packets entering the control zone as well as packets already traveling inside the control zone. As such, control zones may provide a network topology that dynamically tracks and monitor network traffic between authorized and unauthorized devices in a closed loop portion of a network. If a process stops within the closed loop portion, for example, network elements and/or a firewall device may map the process break to a specific location within a control zone.

In some embodiments, a drilling management network may store network information, such as network addresses, network protocols, network dependencies, and port numbers, for each network devices coupled to the drilling management network. Based on this network information, a control zone may limit network communication to authorized locations in the drilling management network. For example, a firewall device may analyze a packet's source device and destination device with a lookup table to determine whether communication is authorized.

In some embodiments, a drilling management network determines a potential security compromise by detecting a packet within an unauthorized communication. For example, where a firewall device obtains a packet for transmission to an unauthorized destination device, the firewall device may provide an alarm notification of the unauthorized communication. Thus, various security compromises in a management zone may be identified to addition to compromises within a control zone.

In Block 430, a packet is terminated in response to a determination that no authorized communication exists between a destination device and a network device in accordance with one or more embodiments. Based on a determination that a packet is not authorized for transmission to a destination device, a firewall device and/or other network elements may terminate the packet. For example, a control zone may perform packet filtering at the edge of the control zone with a firewall device or within a control zone using a switch or other network element.

In one embodiment, for example, if a pump's PLC only needs to communicate with an HMI, then that communication may be the only allowed communication for the pump's PLC within the control zone. If a packet attempts to travel anywhere else within the control zone, the packet is terminated. This termination process may be implemented using switches (e.g., network elements (231, 232, 233) as shown in FIG. 2 between the PLC A (227) and the historian X (224) or the network device Z (226)). Accordingly, in some embodiments, a device analyzes a packet header to determine whether the packet has authorization to communicate with the destination device. For example, network elements within a control zone may ignore the contents, i.e., data in the payload, of a packet and merely filter based on destination network addresses and/or source network address of the packets. In another embodiment, the contents may be reviewed by a network device, e.g., a security agent operating on a host network device. If a source device is authorized to communicate with a destination device, a firewall device may scan the source network address and the destination network address of the packet to make the determination accordingly.

In Block 440, a packet is transmitted to a destination device in response to a determination that communication is authorized between the destination device and a network device in accordance with one or more embodiments. Where a network device is authorized to communicate with a destination device within a control zone, a firewall device and/or other network element may forward the packet through the control zone.

In some embodiments, the network architecture implemented in FIGS. 2, 3, and/or 4 allows a drilling management network to thin down the network resources for PLC control, i.e., by minimizing what resources are needed to operate the pump, etc. On the other side, the management processes for controlling different control systems within a control zone may operate and be placed beyond a firewall device. Metaphorically, a human arm may be analogous to the PLCs of control systems in a control zone. Actual arm movement is functional, but how an arm moves and the destination that an arm is moving may be determined by a brain, which corresponds to a location outside the control zone and beyond a firewall device. In other words, planning and orchestration efforts for control systems may be placed outside the control zone and execution is placed inside the control zone.

Furthermore, security risks may exist in accessing systems in a control zone. For example, remote access may be provided to troubleshoot devices, update control systems, and pull files to and/or from the outside a drilling management network. FIG. 4 and the accompanying description provides secure management protocols that may ensure various automated methods can automatically transmit data into the control zone or obtain data from the control zone without human intervention into the data transfer processes.

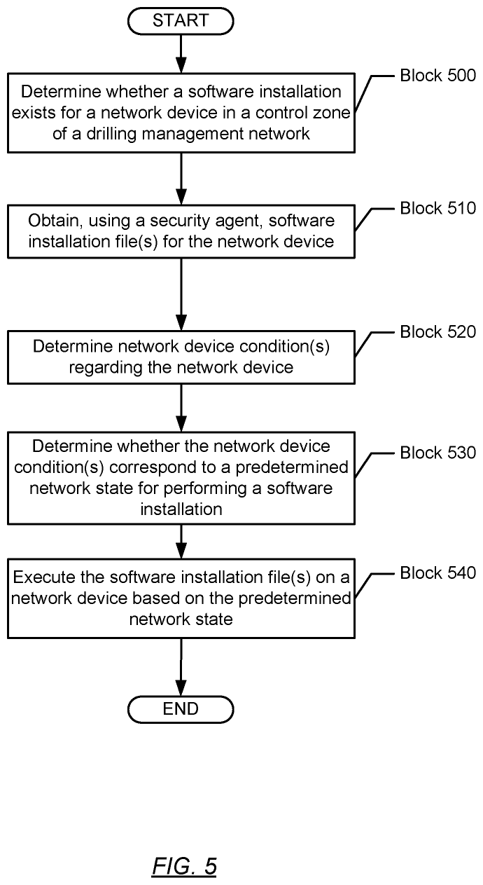

Turning to FIG. 5, FIG. 5 shows a flowchart in accordance with one or more embodiments. Specifically, FIG. 5 describes a method for installing software on a network device in a control zone. For example, the flowchart in FIG. 5 may be performed in addition or separately to the flowchart described in FIG. 4. One or more blocks in FIG. 5 may be performed by one or more components (e.g., security agent C (243)) as described in FIGS. 1, 2, and/or 3. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 500, a determination is made whether a software installation exists for a network device in a control zone of a drilling management network in accordance with one or more embodiments. The network device may be a control system, historian, HMI, or other network device as described in FIG. 2 and the accompanying description. For example, a configuration manager may store software version information regarding control systems and/or other network devices within a control zone of a drilling management network. Accordingly, when a new software version is released, the configuration manager may obtain a notification of the new software version. As such, the configuration manager may automatically determine whether a software update exists for a network device.

Moreover, a configuration manager may obtain a request, e.g., from a human user or an automated process, to install a software application on one or more network devices in a control zone. Rather than replace an existing software version, the configuration manager may orchestrate an entirely new software installation. For example, if a control system is being added to a control zone, one or more software installations may be designated for the added controls system.

In Block 510, one or more software installation files are obtained using a security agent in accordance with one or more embodiments. For example, a configuration manager may communicate with a security agent located on a host network device. The configuration manager may push a software installation file to the device for updating software on the device. For example, the software installation file may be relayed from a configuration manager in a management zone to the host network device in a control zone in a similar manner as described above in FIG. 4 and the accompanying description. In some embodiments, or example a firewall device may search a software installation file before entering a control zone. In some embodiments, a security agent monitors network traffic within a control zone until an available time window occurs for transmitting a software installation file to the host network device.

Once the security agent obtains a software installation file, the file may be placed in storage until a predetermined execution time occurs that is associated with a predetermined network state. For more information on predetermined network states, see Blocks 530 and 540 and the accompanying description below.

In Block 520, one or more network device conditions are determined regarding a network device in accordance with one or more embodiments. In some embodiments, for example, a security agent monitors activity on a host network device, such as drilling operations and/or maintenance operations. As such, network device conditions may correspond to activity on the host network device, e.g., whether the host network device is currently occupied with control operations and not suitable for a software installation. Likewise, network device conditions may also describe activity within a control zone or drilling management network. For example, if other control systems require the host network device to be online for performing various processes, the security agent may identify the dependent control systems among the network device conditions.

In Block 530, a determination is made whether one or more network device conditions correspond to a predetermined network state for performing a software installation in accordance with one or more embodiments. For example, the security agent may prevent a software installation file from being executed until certain network device conditions are met by the host network device. In particular, once a security agent confirms in Block 520 that one or more network device conditions match a predetermined network state, then the security agent may proceed with the software installation. An example of a predetermined network state is when drilling and maintenance operations are terminated at a drilling management network. Another predetermined network state is at a low network traffic period during the night time. Another example of a predetermined network state is when one or more control systems are offline for maintenance, and thus provides a time window for other control systems to perform local operations.

Moreover, once a predetermined state occurs, the security agent may communicate with a configuration manager and/or other network devices in a control zone or management zone to perform the software installation. In some embodiments, a security agent determines a predetermined network state for obtaining the software installation file in Block 510.

In Block 540, one or more software installation files are executed on a network device based on a predetermined network state in accordance with one or more embodiments. For example, a software installation file execution may include modifying one or more settings on the host network device, extracting contents from the file, running software applications with the file, scanning the file for viruses, etc.

Once a predetermined network state is determined, software installation files may be proceed on a host network device while the host network device remains in the predetermined network state. In some embodiments, a security agent may detect a change in the predetermined state and thus automatically terminate the software installation.

Keeping with FIG. 5 and the accompanying description, control systems on a drilling management network have typically been static over time, i.e., control systems may be rarely updated with new software. Thus, the functionality of a device within a control system may rarely change. Because control systems in a drilling rig are production systems, changing software on a network device may result in a huge cost to production. Thus, changes on industrial control side are very slow.

However, as remote access is increasingly provided for control systems, historians, and other network devices within a drilling management network, increasing cybersecurity risks exist due to that level of access. Thus, the processes described above in FIGS. 4 and 5 provide embodiments for both enforcing security within a control zone of a drilling management network, while also adding and/or updating security within the control zone. As such, control system processes may be managed alongside periodic software updates within the control zone, and thereby prevent many cybersecurity threats.

Embodiments may be implemented on a computing system. Any combination of mobile, desktop, server, router, switch, embedded device, or other types of hardware may be used. For example, as shown in FIG. 6.1, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (600) in FIG. 6.1 may be connected to or be a part of a network. For example, as shown in FIG. 6.2, the network (620) may include multiple nodes (e.g., node X (622), node Y (624)). Each node may correspond to a computing system, such as the computing system shown in FIG. 6.1, or a group of nodes combined may correspond to the computing system shown in FIG. 6.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (600) may be located at a remote location and connected to the other elements over a network.

Although not shown in FIG. 6.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6.1. Further, the client device (626) may include and/or perform all or a portion of one or more embodiments of the disclosure.

The computing system or group of computing systems described in FIGS. 6.1 and 6.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file.

Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (600) in FIG. 6.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 6.1, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 6.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 6.1 and the nodes and/or client device in FIG. 6.2. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
connecting a network device to a control zone of a drilling management network, wherein the control zone comprises at least one control system comprising a programmable logic controller configured to perform one or more drilling operations;
validating that the network device is authorized to communicate with a destination device in the control zone;
reconfiguring, in response to validating the network device, the control zone to enable the network device to communicate with the destination device;
obtaining a first packet from the network device; and
transmitting, in response to reconfiguring the control zone, the first packet to the network device.

2. The method of claim 1, further comprising:
transmitting, by the network device, one or more network credentials to a plurality of network devices in the control zone, and
wherein validating the network device comprises analyzing the one or more network credentials to determine which network devices among the plurality of network devices that the network device is authorized to communicate.

3. The method of claim 1,
wherein the network device is disposed outside the control zone and in the drilling management network, and
wherein determining whether the network device is authorized comprises analyzing the first packet by a firewall device disposed between the control zone and the network device.

4. The method of claim 1,
wherein reconfiguring the control zone comprising adjusting, using one or more switches in the control zone, which network addresses are authorized for communication in the control zone.

5. The method of claim 1,
wherein the control zone is a security zone that defines a closed loop portion of the drilling management network.

6. The method of claim 1, further comprising:
obtaining a second packet from a second network for the destination device; and
terminating the second packet in response to determining that the second network device is not authorized to communicate with the destination device.

7. The method of claim 1, further comprising:
analyzing, by a switch in the control zone, the first packet to determine a source network address within the first packet, wherein the source network address is associated with the first network device; and
determining, by the switch, whether a destination network address associated with the destination device is authorized to receive packets from the source network address,
wherein the first packet is transmitted by the switch to the destination device in response to determining that the destination network address is authorized.

8. The method of claim 1,
wherein the destination device comprises a security agent,
wherein the first packet is a portion of a software update file, and
wherein the security agent installs the software update file on the destination device in response to determining a predetermined network state regarding the destination device.

9. The method of claim 1,
wherein determining whether the network device is authorized comprises a certificate-based authentication.

10. A method, comprising:
obtaining, using a security agent operating on a network device, a software installation file from outside a control zone of a drilling management network, wherein the network device is located inside the control zone;
obtaining, by the security agent, one or more network device conditions corresponding to the network device;
determining, by the security agent, whether the one or more network device conditions correspond to a predetermined network state for a software installation on the network device; and
executing, by the security agent, a software installation on the network device using the software update file and in response to determining that the one or more network devices correspond to the predetermined network state.

11. The method of claim 10,
wherein the software installation file is obtained from a configuration manager operating within a management zone of the drilling management network.

12. The method of claim 11, further comprising:
determining that a software update exists for a software application operating on the network device,
wherein the software installation file corresponds to the software update for the software application.

13. The method of claim 10, further comprising:
determining, by a firewall device coupled to the control zone, whether a configuration manager is authorized to communicate with the network device; and
transmitting, in response to determining that the network device and the configuration manager are authorized, a plurality of packets to the network device,
wherein the plurality of packets correspond to the software installation file.

14. The method of claim 10,
wherein the predetermined network state corresponds to a time window when the network device is offline.

15. The method of claim 10,
wherein the network device is a control system comprising a programmable logic controller configured to perform one or more drilling operations.

16. A system, comprising:
a control system coupled to a first plurality of network elements that define a control zone, wherein the control system comprises a security agent and one or more programmable logic controllers (PLCs) configured for performing one or more drilling operations;
a firewall device coupled to the control system; and
a network device and coupled to the firewall device,
wherein the security agent is configured to communicate with the network device through the firewall device, and
wherein the security agent is further configured to install one or more software updates on the control system in response to communicating with the network device.

17. The system of claim 16,
wherein the network device is disposed in a management zone of a drilling management network, the management zone comprising a second plurality of network elements that are coupled to the firewall device,
wherein the first plurality of network elements are configured to provide a closed loop portion of a drilling management network, and
wherein the firewall device is configured to perform a packet inspection on data transmitted from the second plurality of network elements through the firewall device to the first plurality of network elements.

18. The system of claim 16, further comprising:
a switch;
a second control system; and
a human machine interface associated with a first network address,
wherein the switch, the second control system, and the human machine interface are disposed among the first plurality of network elements,
wherein the switch is configured to transmit data to the second control system that only originates from the first network address, and
wherein the switch is further configured to filter data that is associated with a second network address that is different the first network address.

19. The system of claim 16, further comprising:
a configuration manager coupled to the firewall device,
wherein the configuration manager is configured to:
determine that a software update exists for a software application operating on the control system,
transmit, through the firewall device, a software installation file to the security agent on the control system,
wherein the software installation file corresponds to the software update, and
wherein the software installation file is transmitted in response to the firewall device determining that the configuration manager is authorized to communicate with the control system.

20. The system of claim 16,
wherein the firewall device is configured to:
analyze a packet entering the control zone;
determine a source network address within the packet, wherein the source network address is associated with the network device;
determine whether a destination network address associated with the control system is authorized to receive packets from the source network address; and
transmitting the packet to the control system in response to determining that the destination network address is authorized.
